(19) United States
(12) Patent Application Publication
(10) Pub. No.: US 2019/0029298 A1
(43) Pub. Date: Jan. 31, 2019

(54) REPLACING BOBAR (TAPIOCA) DRINK WITH CHIA SEED AS A INGREDENT

(71) Applicant: Wenching Grace Lu, Missouri City, TX (US)

(72) Inventor: Wenching Grace Lu, Missouri City, TX (US)

(21) Appl. No.: 15/660,849

(22) Filed: Jul. 26, 2017

(51) Int. Cl. A23L 25/00; A23L 2/02

(52) U.S. Cl. CPC A23L 25/30; A23V 2002/00; A23L 2/02

(57) ABSTRACT

Chia seeds instead of bobar (tapioca) when soaked in milk tea (traditional and popular Asia drink) 2 to 4 hours (depend upon volume) become jelly like and also chewy which is the main attraction for traditional bobar tapioca drink.

### BACKGROUND

Tapioca (Bo bar) drink is very popular over Asia region. Tapioca is usually mixed with milk tea and tastes like jelly except chewy which is the main attraction for the drink. Tapioca need to be cooked separately and mixed with chilled milk tea later on. Since tapioca is a processed food, there were several incidents that tapiocas were mass produced with cheap and toxic raw materials which caused health issues. Tapioca as a processed food is not easy to be digested, and there were several cases that people got chocked because of the texture. Finding a healthier natural ingredient to replace the processed non-nutritious tapioca is beneficial for the society. Promoting this healthier ingredient through the current vast franchise system will be the goal for this product.

### SUMMARY

Chia seeds when soaked in milk tea for 3 to 4 hours become jelly like and also chewy like traditional bobar (tapioca) drink. The beverage requiring no additional thickening agents is ready to be served after chilled. What is derived is a beverage rich in protein and useful fatty acids.

### BRIEF DESCRIPTION OF THE FIGURES

FIG. 1 shows examples of tapioca (BoBar) drinks

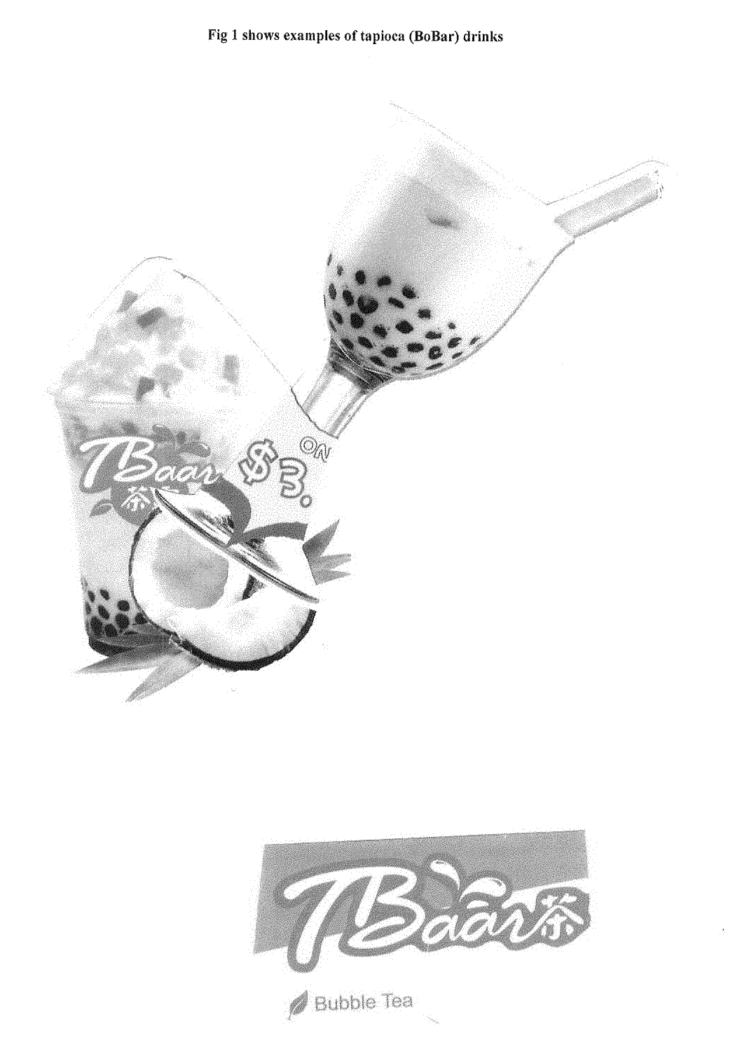

FIG. 2 shows pictures of Chia seeds

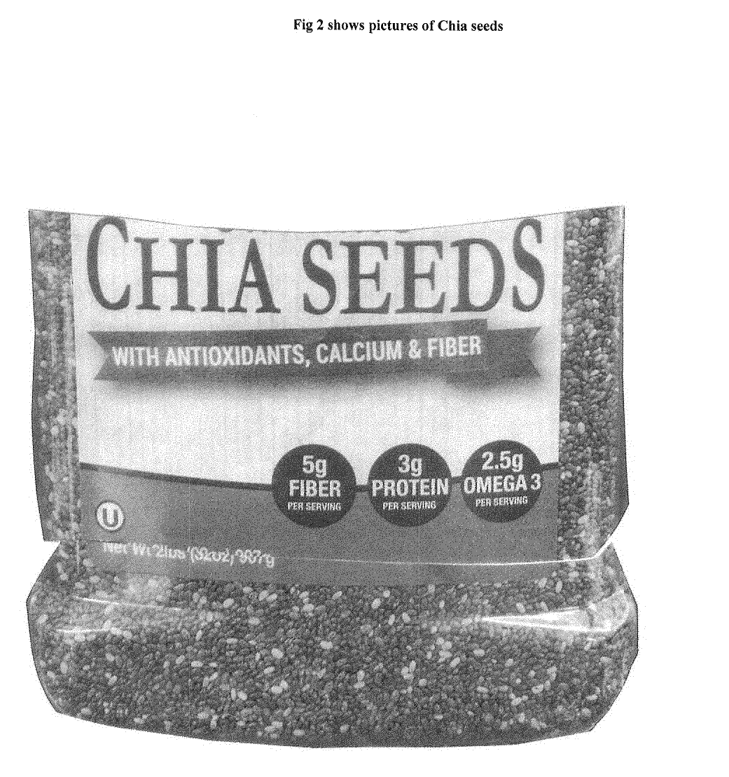

FIG. 3 shows pictures of Chia pudding (Chia seeds with coconut milk)

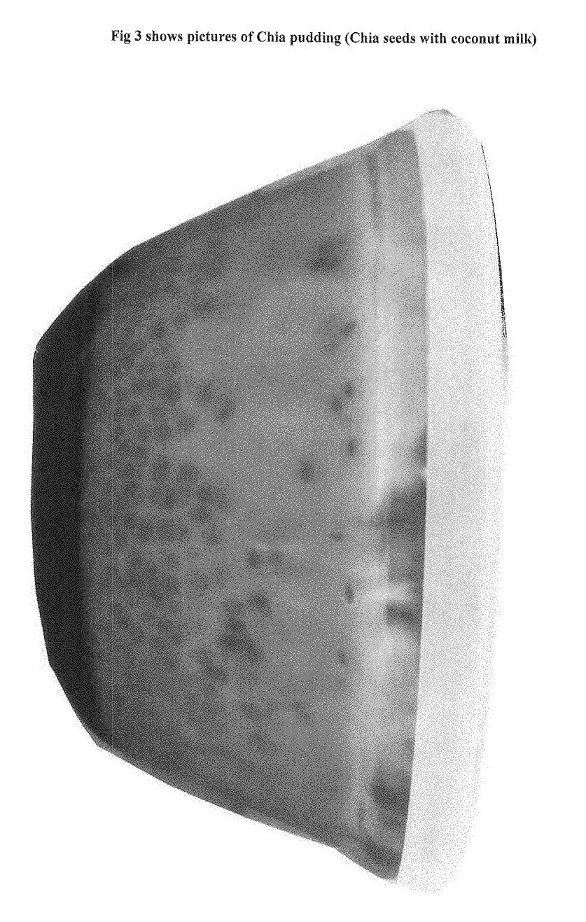

### DETAILED DESCRIPTION

Chia instead of bobar (tapioca) is not currently marketing over the vast tapioca drink franchise system. Chia seeds when soaked in milk tea become jelly like and also chewy which is the main attraction for traditional bobar tapioca drink. Chia seeds as a natural ingredient are high in fiber, providing Vitamin D, Calcium. Iron, Potassium, antioxidants, and an excellent source of Omega 3. Unlike tapioca, Chia seeds are easy to be digested, and don't need to be ground or milled to release their nutritional benefits. As a natural ingredient, Chia seeds don't need to be cooked separately. One quality of Chia seeds is its ability to absorb nearly twelve times its weight in water. Chia seeds contain water soluble fiber that when wet, produces a gel. Simply mix Chia seeds with milk tea couple hours before served will do. Therefore. Chia milk tea is easy to be prepared. Since tapioca is a processed food, there were several incidents that tapiocas were mass produced with cheap and toxic raw materials which caused health issues. Having a Chia instead of bobar tapioca drink, there won't be any risks that the ingredient is mass produced with cheap and toxic raw materials. Researchers believe that Chia gel forms in the digestive tract when eaten. The gel is thought to create a physical barrier between starches, sugars and other carbohydrates consumed by a person and the digestive enzymes that break these carbohydrates down.

### OPERATION

Mix couple tea spoons of Chia seeds with milk tea chilled overnight or couple hours (depend upon quantity) before served. For 8 oz size cup, 3 tea spoons of Chia seeds chilled with milk tea for three hours are good for serving. Mix less tea spoons to have more liquid like drinks. Mix more tea spoons to have more jelly like drink or pudding form. It all depends on the market demand and customers' preference. Merchants could have several types available at the same time.

### ADVANTAGES

Chia seeds as a natural ingredient are high in fiber, providing Vitamin D, Calcium, Iron, Potassium, antioxidants, and an excellent source of Omega 3. Unlike tapioca, Chia seeds are easy to digest, and don't need to be ground or milled to release their nutritional benefits. As a natural ingredient, Chia seeds don't need to be cooked separately. Simply mix Chia seeds with milk tea couple hours before served will do. Therefore; Chia milk tea is easy to be prepared. Also, having a Chia instead of bobar tapioca drink, there won't be any risks that this ingredient is mass produced with cheap and toxic raw materials. Chia seed is a source of dietary protein providing essential amino acids. The unsaturated fatty acids in Chia seed are essential oils the body needs to help emulsified an absorb the fact soluble vitamins A, and D, E, and K.

### CONCLUSION

Chia instead of bobar (tapioca) is not currently marketing over the vast tapioca drink franchise system. Replacing the processed non-nutritious tapioca with the natural healthy Chia ingredient is beneficial for the society. Promoting this healthier ingredient through the current vast franchise system will be the goal for this product.

1. (canceled)

2. (canceled)

3. (canceled)

4. A boba beverage replacing tapioca with soaked chia seeds as the main ingredient,
Said main ingredient comprising:
a) chia seeds fully soaked with around 12 times said chia seeds' weight of liquid becoming jello like are then replacing tapioca balls added to traditionally prepared boba drinks;
b) chia seeds being naturally soaked vs. tapioca balls being traditionally boiled substantially persevere all minerals;
c) chia seeds as raw materials vs. tapioca balls as processed food thereby eliminating the possibility of being mass-produced with toxic chemicals as incidents happened with tapioca ball;
d) said liquid soaking chia seeds is any nutritious ingredients like chocolate milk, coffee, mint tea, etc for flavoring.
